(19) United States
(12) Patent Application Publication
(10) Pub. No.: US 2025/0284542 A1
(43) Pub. Date: Sep. 11, 2025

(54) APPARATUSES AND METHODS FOR DETECTING DUPLICATE WORKLOADS AND OUTPUTS IN RESPECT OF NETWORK AND SYSTEM GRAPHS

(71) Applicant: CIENA CORPORATION, Hanover, MD (US)

(72) Inventors: GURPREET SINGH, Amristsar (IN); Pravin Tripathi, Lucknow (IN)

(73) Assignee: CIENA CORPORATION, Hanover, MD (US)

(21) Appl. No.: 18/638,832

(22) Filed: Apr. 18, 2024

(30) Foreign Application Priority Data
Mar. 6, 2024 (IN) 202411015819

(51) Int. Cl. G06F 9/50

(52) U.S. Cl. CPC G06F 9/5027

(57) ABSTRACT

Aspects of the subject disclosure may include, for example, obtaining a graph, partitioning the graph to generate a plurality of subgraphs, segmenting the plurality of subgraphs to obtain a plurality of segmented subgraphs, determining that at least a first segmented subgraph of the plurality of segmented subgraphs and a second segmented subgraph of the plurality of segmented subgraphs are redundant to one another, resulting in a first redundancy, and eliminating the first redundancy. Other embodiments are disclosed.

### CROSS-REFERENCE TO RELATED APPLICATIONS

The instant application claims priority to India patent application No. 202411015819, filed on Mar. 6, 2024. All sections of the aforementioned application(s) are incorporated herein by reference in their entirety.

### FIELD OF THE DISCLOSURE

The subject disclosure relates to apparatuses and methods for detecting duplicate workloads and outputs in respect of network and system graphs.

### BACKGROUND

As the world increasingly becomes connected via vast communication networks and systems and via various communication devices, additional opportunities are created/generated to provision communication services. Most modern network/system graph processing frameworks leverage cloud computing resources to process workloads associated with different portions of graphs (i.e., subgraphs) in parallel. In this respect, enhancements in efficiency may be obtained (relative to a scenario where the subgraphs are processed serially or sequentially) as the overall amount of time it takes to process a set of workloads may be reduced.

While a parallel processing of subgraphs has been demonstrated to yield efficiency gains, the independence between processing resources that are utilized to process the subgraphs implies that there may be instances where the processing is redundant. For example, it may be the case that a first subgraph and a second subgraph have common associated workloads or features, potentially yielding common processing results/outputs. If, in this example, the first and second subgraphs were to be processed in parallel, this implies that processing resources associated with one of the subgraphs may be consumed/utilized unnecessarily. This redundancy (and thus, inefficiency) may have significant implications in relation to modern networks and systems that are large in size/scale.

### BRIEF SUMMARY OF THE DISCLOSURE

The subject disclosure describes, among other things, illustrative embodiments for preserving scarce resources by deduplicating, or eliminating redundancy in respect of, workloads and outputs/results in accordance with various aspects set forth herein. Other embodiments are described in the subject disclosure.

### BRIEF DESCRIPTION OF THE DRAWINGS

Reference will now be made to the accompanying drawings, which are not necessarily drawn to scale, and wherein:

FIG. 1 illustrates a graph of at least a portion of a communication network or system in accordance with various aspects described herein.

FIG. 2 depicts an illustrative embodiment of a method for deduplicating workloads and outputs/results in accordance with various aspects set forth herein.

FIG. 3A depicts an illustrative embodiment of a method for partitioning a graph in accordance with aspects of this disclosure.

FIG. 3B depicts an illustrative embodiment of a method for performing segmentation in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

### DETAILED DESCRIPTION

One or more aspects of the subject disclosure include, in whole or in part, obtaining a graph; partitioning the graph to generate a plurality of subgraphs; segmenting the plurality of subgraphs to obtain a plurality of segmented subgraphs; determining that at least a first segmented subgraph of the plurality of segmented subgraphs and a second segmented subgraph of the plurality of segmented subgraphs are redundant to one another, resulting in a first redundancy; and eliminating the first redundancy.

One or more aspects of the subject disclosure include, in whole or in part, obtaining, by a processing system including a processor, a graph; partitioning, by the processing system, the graph to generate a plurality of subgraphs; segmenting, by the processing system, the plurality of subgraphs to obtain a plurality of segmented subgraphs; determining, by the processing system, that at least a first segmented subgraph of the plurality of segmented subgraphs and a second segmented subgraph of the plurality of segmented subgraphs are redundant to one another, resulting in a first redundancy; and eliminating, by the processing system, the first redundancy.

One or more aspects of the subject disclosure include, in whole or in part, determining, based on a comparison of a first hash value associated with a first subgraph and a second hash value associated with a second subgraph, that the first subgraph and the second subgraph are duplicates of one another; and based on the determining, performing deduplication by scheduling a single instance of a workload for processing, the workload being associated with each of the first subgraph and the second subgraph; and processing the workload based on the scheduling.

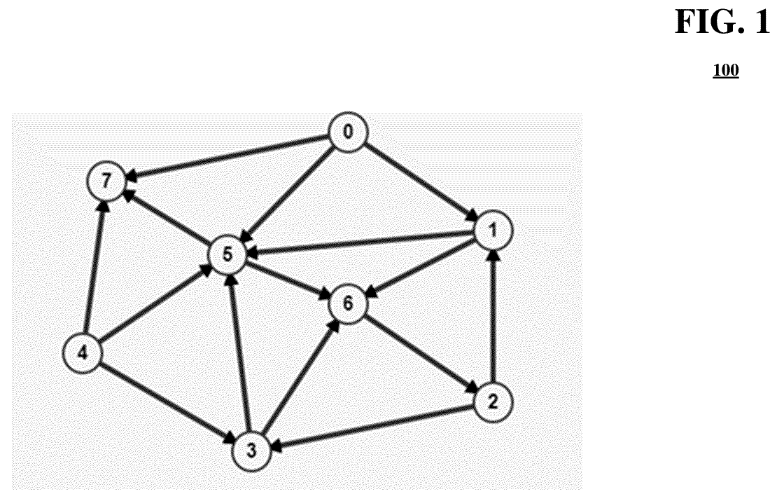

Referring to FIG. 1, an example of a graph 100 in accordance with various aspects of this disclosure is shown. The graph 100 may be representative of a network or a system (or one or more portions thereof). The graph 100 may be composed of, or include, a number of nodes or vertices, such as the nodes labeled 0, 1, 2, 3, 4, 5, 6, and 7 as shown in the exemplary embodiment of FIG. 1. A given node of the graph 100 may be coupled or connected to at least one other node by way of an arc or edge. An edge may represent a relationship between the nodes that it couples/connects. Further, the edges are shown as being directed (as represented by the arrowheads in FIG. 1), and thus the graph 100 may be referred to as a directed graph. It is understood and appreciated that aspects of this disclosure may be implemented or practiced with respect to other types or kinds of graphs, such as undirected graphs.

In some embodiments, a node of a graph may include, or be associated with, one or more features. For example, and without limitation, features of a node may include: a network/system identifier (corresponding to a unique identifier of a network or system where the node is located), a node identifier (corresponding to a unique identifier of the node within the network or system where the node is located), properties (corresponding to attributes of the node, such as state information of the node), characteristics, and/or policies (such as, for example, user-defined policies that may dictate or influence a computation applicable to the node).

As referenced above, a graph (e.g., the graph 100) may be associated with one or more computational/processing tasks or workloads. For purposes of scheduling or managing such tasks/workloads, an entity or data structure may be defined and utilized. The data structure may include a context of a workload and a payload of the workload. The context may include an identifier that may correspond to a trace or session identifier that may be attached to, or associated with, the graph at the time that the computation is triggered/initiated. The context may include a timestamp of when the workload is created/generated and/or processed. The payload may correspond to or include the data or information that is to be processed, where such data/information may be associated with a subgraph of the graph.

One or more computational algorithms or functions may be utilized to process the graph (or associated subgraphs). Generally, the algorithms/functions may be deterministic in nature, with few exceptions; this implies that, in the absence of an exception and given a fixed input, the outputs/results that are generated will be the same irrespective of the resource (e.g., server, machine, etc.) that is used to process the input or how many times the algorithms/functions are executed. The deterministic nature may be exploited to efficiently allocate the subgraphs (or associated tasks/workloads) amongst resources that are available.

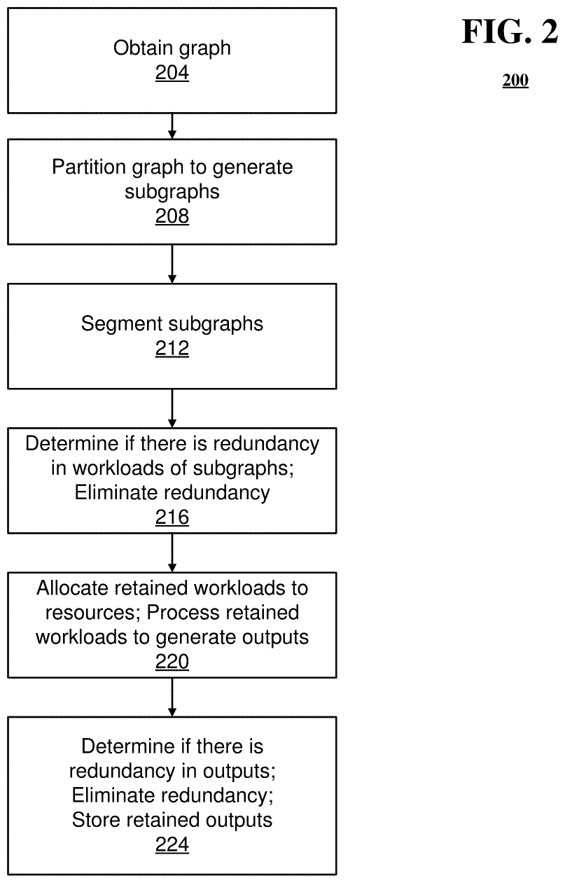

With reference now to FIG. 2, an illustrative embodiment of a method 200 in accordance with various aspects described herein is shown. The method 200 may be implemented (e.g., executed), in whole or in part, in conjunction with one or more systems, networks, devices, or components, such as for example the systems, networks, devices, and components described herein. The method 200 may facilitate a performance of operations, where such operations are represented by the blocks shown in FIG. 2. The operations may be facilitated via instructions that may be executed by one or more processing systems (where each such processing system may include one or more processors).

In block 204, a graph may be obtained. The graph may be representative of a network or system (or one or more parts/portions thereof).

In block 208, the graph obtained as part of block 204 may be decomposed using one or more partitioning techniques. Examples of such techniques are described in further detail below. The partitioning applied as part of block 208 may result in a number of subgraphs that may be obtained from the graph of block 204.

In block 212, the subgraphs obtained as part of block 208 may be subjected to segmentation. Various techniques that may be used to obtain/provide such segmentation are described below.

In block 216, a determination may be made whether a first workload/task associated with a first subgraph is a duplicate of at least a second workload/task associated with at least a second subgraph. The determination of block 216 may be based on, or facilitated by, the segmentation of block 212, as described in further detail below. To the extent that there is any duplication/redundancy amongst the workloads/tasks, such duplication/redundancy may be eliminated as part of block 216. For example, the duplication/redundancy may be eliminated by merely retaining one of the redundant workloads/tasks (effectively discarding of a remainder of the redundant workloads/tasks).

Following any deduplication in block 216, any non-redundant, retained workloads/tasks may be scheduled and/or processed as part of block 220. Block 220 may include an allocation of the retained workloads/tasks to particular resources (e.g., servers, machines, etc.). Any processing performed as part of block 220 may generate/yield one or more outputs or results.

In block 224, a determination may be made whether a first output/result generated as part of block 220 is the same as, or redundant to, a second output/result generated as part of block 220. As used in this context, the first and second outputs may be termed as being the same or redundant if they are identical or within a threshold of one another. To the extent that there are any same/redundant outputs/results, instances of those outputs/results may be discarded/eliminated such that a single instance of the outputs/results is retained. Following any such discarding/eliminating, the remaining, retained outputs/results may be stored (such as in a database, a memory, or the like) as part of block 224.

As described above (see, e.g., the description associated with block 208), partitioning may be used to decompose a graph into constituent subgraphs. A selection of a partition/partitioning strategy or technique to utilize may depend on one or more factors or considerations, such as one or more specifications, requirements, or the like that may be in-force, an identification of applications that are being supported or executed, etc. In some embodiments, one or more clustering algorithms may be used to facilitate the partitioning of the graph.

In some embodiments, the partitioning may be based on controlled and domain-aware techniques. A partition size (denoted by a variable ‘K’ in the description that follows) may correspond to, or represent, a maximum number of participating vertices/nodes that is allowed in each partition. The value of ‘K’ may be different for different graph domains. By way of example, a layer0 optical network graph may utilize a value of ‘K’ within a range of two to three [2, 3], where such a value may be based on a recognition/identification that duplication may be high due to symmetrical multiplex/demultiplexer (MUX/DEMUX) structures in the corresponding network.

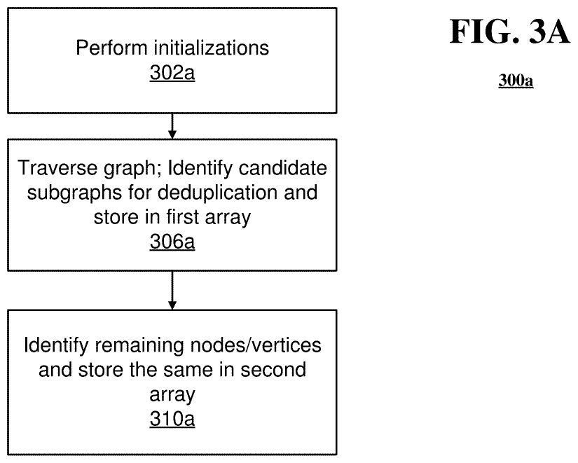

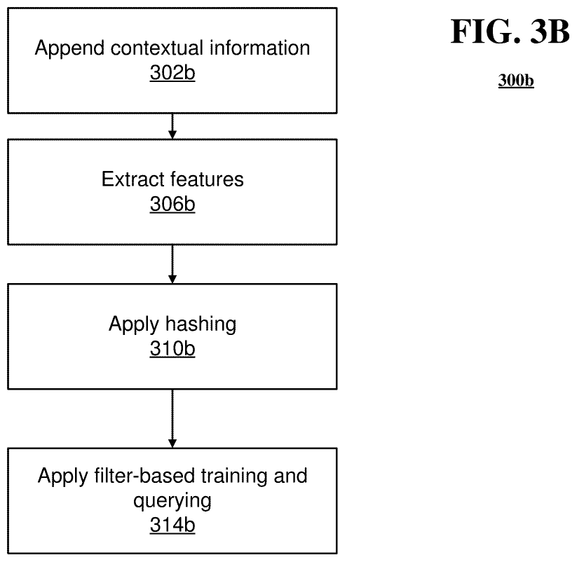

With reference now to FIG. 3A, a flowchart of a method 300a for performing a partitioning of a graph in accordance with various aspects of this disclosure is shown. The method 300a may be utilized to facilitate one or more operations of block 208 of FIG. 2.

In block 302a, one or more initializations may be performed/undertaken. For example, in block 302a the value of ‘K’ (corresponding to the partition size described above) may be established, and two vectors or arrays may be established. A first of the vectors/arrays may be referred to as Candidate-Partitions-For-Deduplication. A second of the vectors/arrays may be referred as Partitions-Not-For-Deduplication. The use of such nomenclature in respect of the first and second vectors/arrays will become more apparent below.

In block 306a, a subject graph (see, e.g., graph 100 of FIG. 1; see also block 204 of FIG. 2) may be traversed (e.g., “crawled”) to identify subgraphs (e.g., one-dimensional subgraphs) that satisfy the partition size ‘K’. To the extent that any such subgraphs are identified, they may be pushed into, or stored as part of, a first array (e.g., the array Candidate-Partitions-For-Deduplication).

Subsequent to the traversal of the graph as part of block 306a, any remaining, unvisited vertices/nodes may be pushed into, or stored as part of, a second array (e.g., the array Partitions-Not-For-Deduplication) as part of block 310a.

Following the execution of block 310a, the first array Candidate-Partitions-For-Deduplication may hold/store the subgraphs that are candidates for deduplication as described in further detail below (see also block 216 of FIG. 2 regarding elimination of redundancy). The second array Partitions-Not-For-Deduplication may contain subgraphs (or nodes) that are not candidates for deduplication, such that any workloads associated therewith may be scheduled to be executed/processed (e.g., as part of block 220 of FIG. 2).

To demonstrate by way of example, and assuming that the value of ‘K’ was set equal to three (3), the execution of the method 300a upon the graph 100 of FIG. 1 may result in twenty subgraphs, which include: {0,5,7}, {0,1,5}, {0,1,6}, {1,6,2}, {1,5,7}, {1,5,6}, {2,1,5}, {2,1,6}, {2,3,5}, {2,3,6}, {3,6,2}, {3,5,6}, {3,5,7}, {4,5,7}, {4,5,6}, {4,3,6}, {4,3,5}, {5,6,2}, {6,2,1} and {6,2,3}.

To continue with the example of the method 200 of FIG. 2 being applied to the graph 100 of FIG. 1 with the value of ‘K’ set equal to three, and with specific reference to block 212 of FIG. 2, the twenty subgraphs identified above may be subjected to segmentation. The method 300b shown in FIG. 3B may be utilized to facilitate the segmentation.

In block 302b, contextual information may be appended. To demonstrate with respect to the first of the twenty subgraphs referenced above, the subgraph {0,5,7} may be appended with a representation of S1 and T1. For example, following an execution of block 302b upon the first subgraph the first subgraph may be modified to {0,5,7_S1_T1}, where S1 may correspond to a session identifier and T1 may correspond to a timestamp as referenced above. Similarly, the second subgraph {0,1,5} may become {0,1,5_S1_T1}. For purposes of explanation going forward, it may be assumed that in this particular example that all twenty of the subgraphs are appended with S1 and T1, with the understanding that other values (e.g., S2 and T2) may be used as part of block 302b.

In block 306b, features may be extracted. As part of block 306b, targeted features may be identified to yield/obtain a focus on particular parameters (e.g., properties, characteristics, policies) of interest (e.g., optical fibers composed of a particular material, optical fibers having a certain minimum length, fibers conveying optical signals with particular frequencies or utilizing particular frequency bands, etc.). Such features may be extracted in respect of the appended subgraphs of block 302b. To demonstrate, following the operations of block 306b the first four subgraphs of the twenty subgraphs may be represented as:
{0,5,7_S1_T1} Features (Properties=X, Characteristics=Y, Policies=Z),
{0,1,5_S1_T1} Features (Properties=X, Characteristics=Y, Policies=Z),
{0,1,6_S1_T1} Features (Properties=X, Characteristics=Y, Policies=Z), and
{1,6,2_S1_T1} Features (Properties=P, Characteristics=Q, Policies=R).
In block 310b, hashing may be applied in respect of the features extracted/identified as part of block 306b. To demonstrate, a hash/hashing function applied to the features of the first three subgraphs may yield a common, first hash value (e.g., V1), whereas application of the hash/hashing function to the fourth subgraph may yield a second hash value (e.g., V2) that is different from the first hash value.

In block 314b, a filter-based training and querying may be applied or performed. For example, block 314b may involve an application or use of a bloom filter, whereby a query may be made whether any particular subgraph has corresponding features with any other subgraphs (as fairly represented by a comparison involving the hash values). If the query is answered in the affirmative (meaning that the comparison involving the hash values yields a match), then the comparison has served to identify duplicate subgraphs, such that a process or procedure for eliminating the duplicates/redundancy may be engaged in (see, e.g., block 216 of FIG. 2). Conversely, if the query is answered in the negative (meaning that the comparison involving the hash values does not yield a match) that may be indicative of a unique subgraph that warrants scheduling of a processing of the associated workload (see, e.g., block 220 of FIG. 2). The training of the filter may entail a storage of outputs of the processing, potentially subject to an elimination in redundancy in the outputs as described above in connection with block 224 of FIG. 2.

While for purposes of simplicity of explanation, the respective processes are shown and described as a series of blocks in FIGS. 2, 3A, and 3B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. Operations associated with one or more blocks can be performed in response to, or based on, operations associated with one or more other blocks.

As one skilled in the art will appreciate, features of block 216 (for example, elimination of redundant workloads/tasks) of FIG. 2 may help to conserve scarce computing/processing resources in practical applications involving communication networks and systems. Indeed, many workloads/tasks of practical applications may take on the order of minutes, hours, or even days to process (as part of block 220 of FIG. 2). In this respect, by eliminating the redundancy in workloads/tasks, significant computing/processing resource savings may be realized/obtained, thereby representing significant improvements to technology. Similarly, features of block 224 (for example, an elimination of redundant outputs/results) of FIG. 2 may help to converse scarce storage resources as part of practical applications involving communication networks and systems. Indeed, the outputs/results of processing (of block 220 of FIG. 2) in practical applications may be large in nature (e.g., on the order of Megabytes or Gigabytes), such that significant storage resource savings may be realized/obtained, thereby representing significant improvements to technology. Further, and all other conditions being assumed equal, by reducing the processing and storage that is needed, less processing/storage resources may be required. This, in turn, may yield/provide a reduction in power consumption. In brief, and as demonstrated, the various aspects of this disclosure (inclusive of aspects of the various operations and methods set forth herein) are not directed to abstract ideas. To the contrary, the various aspects of this disclosure are directed to, and encompass, significantly more than any abstract idea standing alone.

Aspects of this disclosure may be used for detecting duplicate network/system graph workloads contextually. These techniques can significantly enhance (e.g., optimize) the scheduling of graphs (or associated workloads) that are highly susceptible to duplication. The employment of a Bloom filter (or similar data structure), known for space efficiency and quick querying, may further enhance the overall performance/efficiency. Cancelling duplicate, yet complex, workloads can significantly enhance the efficiency of available computational/processing resources, while also reducing the overall turnaround time for network/system graph processing. Moreover, discarding duplicate results can contribute to enhanced (e.g., optimal) storage resource usage. Aspects of this disclosure may be applied in respect of communication networks and systems of various types or kinds, including wired/wireline networks/systems, wireless networks/systems, fiber networks/systems, etc. Aspects of this disclosure may be utilized in respect of data centers, server farms/clusters, etc. As one skilled in the art will appreciate, aspects of this disclosure may facilitate network/system planning operations, maintenance operations, troubleshooting operations, etc., by reducing an amount of time it takes to arrive at results that are relevant/pertinent to the particular tasks or discipline(s) at hand.

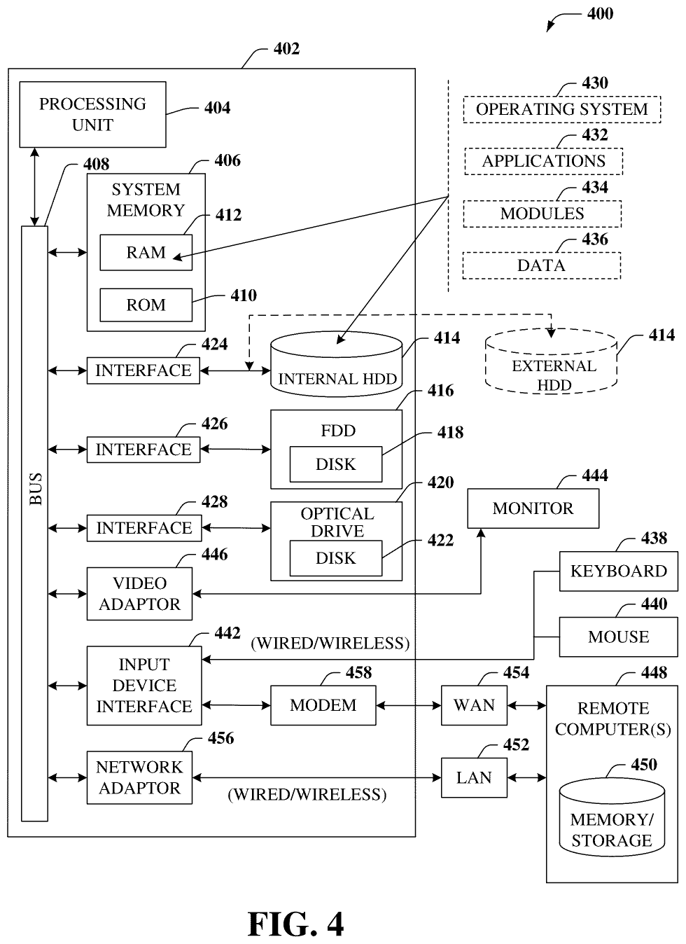

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, the computing environment 400 can be used in computing device described herein. Each of these devices can be implemented via computer-executable instructions that can run on one or more computers, and/or in combination with other program modules and/or as a combination of hardware and software. For example, the computing environment 400 can facilitate, in whole or in part, obtaining a graph, partitioning the graph to generate a plurality of subgraphs, segmenting the plurality of subgraphs to obtain a plurality of segmented subgraphs, determining that at least a first segmented subgraph of the plurality of segmented subgraphs and a second segmented subgraph of the plurality of segmented subgraphs are redundant to one another, resulting in a first redundancy, and eliminating the first redundancy. The computing environment 400 can facilitate, in whole or in part, obtaining, by a processing system including a processor, a graph, partitioning, by the processing system, the graph to generate a plurality of subgraphs, segmenting, by the processing system, the plurality of subgraphs to obtain a plurality of segmented subgraphs, determining, by the processing system, that at least a first segmented subgraph of the plurality of segmented subgraphs and a second segmented subgraph of the plurality of segmented subgraphs are redundant to one another, resulting in a first redundancy, and eliminating, by the processing system, the first redundancy. The computing environment 400 can facilitate, in whole or in part, determining, based on a comparison of a first hash value associated with a first subgraph and a second hash value associated with a second subgraph, that the first subgraph and the second subgraph are duplicates of one another, and based on the determining, performing deduplication by scheduling a single instance of a workload for processing, the workload being associated with each of the first subgraph and the second subgraph, and processing the workload based on the scheduling.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

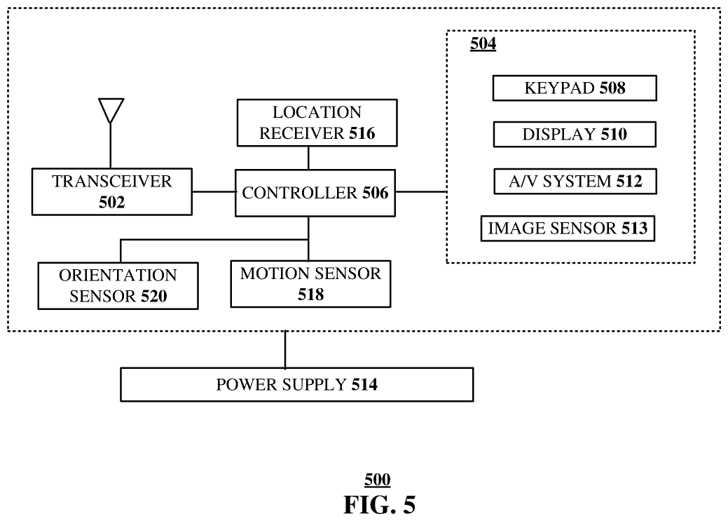

Turning now to FIG. 5, an illustrative embodiment of a communication device 500 is shown. The communication device 500 can facilitate, in whole or in part, obtaining a graph, partitioning the graph to generate a plurality of subgraphs, segmenting the plurality of subgraphs to obtain a plurality of segmented subgraphs, determining that at least a first segmented subgraph of the plurality of segmented subgraphs and a second segmented subgraph of the plurality of segmented subgraphs are redundant to one another, resulting in a first redundancy, and eliminating the first redundancy. The communication device 500 can facilitate, in whole or in part, obtaining, by a processing system including a processor, a graph, partitioning, by the processing system, the graph to generate a plurality of subgraphs, segmenting, by the processing system, the plurality of subgraphs to obtain a plurality of segmented subgraphs, determining, by the processing system, that at least a first segmented subgraph of the plurality of segmented subgraphs and a second segmented subgraph of the plurality of segmented subgraphs are redundant to one another, resulting in a first redundancy, and eliminating, by the processing system, the first redundancy. The communication device 500 can facilitate, in whole or in part, determining, based on a comparison of a first hash value associated with a first subgraph and a second hash value associated with a second subgraph, that the first subgraph and the second subgraph are duplicates of one another, and based on the determining, performing deduplication by scheduling a single instance of a workload for processing, the workload being associated with each of the first subgraph and the second subgraph, and processing the workload based on the scheduling.

The communication device 500 can comprise a wireline and/or wireless transceiver 502 (herein transceiver 502), a user interface (UI) 504, a power supply 514, a location receiver 516, a motion sensor 518, an orientation sensor 520, and a controller 506 for managing operations thereof. The transceiver 502 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 502 can also be adapted to support circuit-switched wireline access technologies (such as PSTN), packet-switched wireline access technologies (such as TCP/IP, VOIP, etc.), and combinations thereof.

The UI 504 can include a depressible or touch-sensitive keypad 508 with a navigation mechanism such as a roller ball, a joystick, a mouse, or a navigation disk for manipulating operations of the communication device 500. The keypad 508 can be an integral part of a housing assembly of the communication device 500 or an independent device operably coupled thereto by a tethered wireline interface (such as a USB cable) or a wireless interface supporting for example Bluetooth®. The keypad 508 can represent a numeric keypad commonly used by phones, and/or a QWERTY keypad with alphanumeric keys. The UI 504 can further include a display 510 such as monochrome or color LCD (Liquid Crystal Display), OLED (Organic Light Emitting Diode) or other suitable display technology for conveying images to an end user of the communication device 500. In an embodiment where the display 510 is touch-sensitive, a portion or all of the keypad 508 can be presented by way of the display 510 with navigation features.

The display 510 can use touch screen technology to also serve as a user interface for detecting user input. As a touch screen display, the communication device 500 can be adapted to present a user interface having graphical user interface (GUI) elements that can be selected by a user with a touch of a finger. The display 510 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 510 can be an integral part of the housing assembly of the communication device 500 or an independent device communicatively coupled thereto by a tethered wireline interface (such as a cable) or a wireless interface.

The UI 504 can also include an audio system 512 that utilizes audio technology for conveying low volume audio (such as audio heard in proximity of a human ear) and high-volume audio (such as speakerphone for hands free operation). The audio system 512 can further include a microphone for receiving audible signals of an end user. The audio system 512 can also be used for voice recognition applications. The UI 504 can further include an image sensor 513 such as a charged coupled device (CCD) camera for capturing still or moving images.

The power supply 514 can utilize common power management technologies such as replaceable and rechargeable batteries, supply regulation technologies, and/or charging system technologies for supplying energy to the components of the communication device 500 to facilitate long-range or short-range portable communications. Alternatively, or in combination, the charging system can utilize external power sources such as DC power supplied over a physical interface such as a USB port or other suitable tethering technologies.

The location receiver 516 can utilize location technology such as a global positioning system (GPS) receiver capable of assisted GPS for identifying a location of the communication device 500 based on signals generated by a constellation of GPS satellites, which can be used for facilitating location services such as navigation. The motion sensor 518 can utilize motion sensing technology such as an accelerometer, a gyroscope, or other suitable motion sensing technology to detect motion of the communication device 500 in three-dimensional space. The orientation sensor 520 can utilize orientation sensing technology such as a magnetometer to detect the orientation of the communication device 500 (north, south, west, and east, as well as combined orientations in degrees, minutes, or other suitable orientation metrics).

The communication device 500 can use the transceiver 502 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 506 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 500.

Other components not shown in FIG. 5 can be used in one or more embodiments of the subject disclosure. For instance, the communication device 500 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A non-transitory machine-readable medium, comprising executable instructions that, when executed by processing system including a processor, facilitate performance of operations, the operations comprising:
obtaining a graph;
partitioning the graph to generate a plurality of subgraphs;
segmenting the plurality of subgraphs to obtain a plurality of segmented subgraphs;
determining that at least a first segmented subgraph of the plurality of segmented subgraphs and a second segmented subgraph of the plurality of segmented subgraphs are redundant to one another, resulting in a first redundancy; and
eliminating the first redundancy.

2. The non-transitory machine-readable medium of claim 1, wherein the eliminating of the first redundancy comprises scheduling only a single instance of a workload for processing, wherein the workload is associated with each of the first segmented subgraph and the second segmented subgraph.

3. The non-transitory machine-readable medium of claim 2, wherein the scheduling comprises allocating the workload to at least one machine of a cloud computing framework for the processing of the workload.

4. The non-transitory machine-readable medium of claim 1, wherein the graph corresponds to at least a portion of a communication network or system.

5. The non-transitory machine-readable medium of claim 4, wherein the portion includes a fiber link.

6. The non-transitory machine-readable medium of claim 1, wherein the operations further comprise:
subsequent to the eliminating of the first redundancy, scheduling for processing a plurality of workloads associated with a remainder of the plurality of segmented subgraphs;
based on the scheduling, obtaining a plurality of outputs;
determining that at least a first output of the plurality of outputs and a second output of the plurality of outputs are redundant to one another, resulting in a second redundancy; and
eliminating the second redundancy.

7. The non-transitory machine-readable medium of claim 6, wherein the eliminating of the second redundancy comprises storing only a single instance of the first output and the second output.

8. The non-transitory machine-readable medium of claim 6, wherein the first output is generated prior to the second output, and wherein the determining that the first output and the second output are redundant to one another comprises:
querying a database where the first output is stored; and
determining, based on the querying, that the second output matches the first output.

9. The non-transitory machine-readable medium of claim 1, wherein the partitioning comprises a traversal of the graph to identify a first plurality of subgraphs included in the plurality of subgraphs that satisfy a partition size, the partition size representing a maximum number of participating vertices included in the graph that is allowed in each partition of the graph.

10. The non-transitory machine-readable medium of claim 9, wherein the traversal of the graph identifies a plurality of vertices of the graph that do not satisfy the partition size, the operations further comprising:
scheduling for processing workloads associated with the plurality of vertices.

11. The non-transitory machine-readable medium of claim 1, wherein the segmenting of the plurality of subgraphs comprises:
extracting at least one feature from each subgraph of the plurality of subgraphs,
wherein the determining is based on a comparison of a respective at least one feature of the first segmented subgraph and a respective at least one feature of the second segmented subgraph in accordance with the extracting.

12. The non-transitory machine-readable medium of claim 11, wherein the operations further comprising:
generating a first hash value based on the respective at least one feature of the first segmented subgraph; and
generating a second hash value based on the respective at least one feature of the second segmented subgraph,
wherein the comparison is based on the first hash value and the second hash value.

13. The non-transitory machine-readable medium of claim 1, wherein the determining comprises determining that a first output associated with the first segmented subgraph and a second output associated with the second segmented subgraph are within a threshold of one another.

14. A method, comprising:
obtaining, by a processing system including a processor, a graph;
partitioning, by the processing system, the graph to generate a plurality of subgraphs;
segmenting, by the processing system, the plurality of subgraphs to obtain a plurality of segmented subgraphs;
determining, by the processing system, that at least a first segmented subgraph of the plurality of segmented subgraphs and a second segmented subgraph of the plurality of segmented subgraphs are redundant to one another, resulting in a first redundancy; and
eliminating, by the processing system, the first redundancy.

15. The method of claim 14, wherein the plurality of subgraphs includes a first plurality of subgraphs that satisfies a partition size and a second plurality of subgraphs that does not satisfy the partition size, the method further comprising:
scheduling, by the processing system, for processing workloads associated with the second plurality of subgraphs based on a determination that each of the second plurality of subgraphs does not satisfy the partition size.

16. The method of claim 14, wherein the segmenting comprises extracting first features from a first subgraph of the plurality of subgraphs and second features from a second subgraph of the plurality of subgraphs, the first subgraph being associated with the first segmented subgraph and the second subgraph being associated with the second segmented subgraph, and wherein the determining is based on a comparison of the first features and the second features.

17. A non-transitory machine-readable medium, comprising executable instructions that, when executed by processing system including a processor, facilitate performance of operations, the operations comprising:
determining, based on a comparison of a first hash value associated with a first subgraph and a second hash value associated with a second subgraph, that the first subgraph and the second subgraph are duplicates of one another; and
based on the determining, performing deduplication by scheduling a single instance of a workload for processing, the workload being associated with each of the first subgraph and the second subgraph; and
processing the workload based on the scheduling.

18. The non-transitory machine-readable medium of claim 17, wherein the first subgraph and the second subgraph are representations of portions of a communication network.

19. The non-transitory machine-readable medium of claim 18, wherein the communication network includes a fiber communication network.

20. The non-transitory machine-readable medium of claim 19, wherein the communication network includes a wireless communication network.
